(19) United States
(12) Patent Application Publication
(10) Pub. No.: US 2016/0343393 A1
(43) Pub. Date: Nov. 24, 2016

(54) MAGNETIC DISK DEVICE AND POSITION CONTROL METHOD

(71) Applicant: Kabushiki Kaisha Toshiba, Tokyo (JP)

(72) Inventor: Masafumi Iwashiro, Yokohama Kanagawa (JP)

(21) Appl. No.: 14/846,625

(22) Filed: Sep. 4, 2015

Related U.S. Application Data
(60) Provisional application No. 62/164,000, filed on May 20, 2015.

(51) Int. Cl. G11B 5/596; G11B 20/10

(52) U.S. Cl. CPC G11B 5/59627; G11B 20/10046

(57) ABSTRACT

According to an embodiment, a magnetic disk device includes a head and a controller. The head reads servo information on a disk. The controller performs position control for the head by using a high-order adaptive digital filter including a first variable coefficient and a second variable coefficient each based on positional error information generated from the servo information read by the head.

### CROSS-REFERENCE TO RELATED APPLICATIONS

This application is based upon and claims the benefit of priority from U.S. Provisional Application No. 62/164,000, filed on May 20, 2015; the entire contents of which are incorporated herein by reference.

### FIELD

Embodiments described herein relate generally to a magnetic disk device, and position control method.

### BACKGROUND

In the related art, there is a proposed technique in which a position of a head to read and write data relative to a magnetic disk is controlled in a magnetic disk device. For example, a feedback control is applied to position control for a head, in which position control for the head is performed by controlling a VCM based on information obtained by applying filtering processing to positional error information of the head.

As for this technique of position control for the head in the magnetic disk device proposed in the related art, more improvement is required in its accuracy.

### BRIEF DESCRIPTION OF THE DRAWINGS

FIG. 1 is a block diagram illustrating a configuration of a magnetic disk device according to a first embodiment;

FIG. 2 is a diagram illustrating an exemplary configuration of a sector of a magnetic disk;

FIG. 3 is a diagram illustrating an exemplary configuration to perform position control for a head of the first embodiment;

FIG. 4 is a block diagram illustrating an exemplary configuration of an adaptive filter according to the first embodiment;

FIG. 5 is a flowchart illustrating a procedure of calculation processing for a coefficient to be set at an HDD in an information processor of the first embodiment;

FIG. 6 is a flowchart illustrating a procedure of processing performed by the adaptive filter of the first embodiment;

FIG. 7 is a diagram illustrating transition of an adaptation coefficient relative to an elapsed time at the adaptive filter of the first embodiment;

FIG. 8 is a diagram illustrating transition of a positional error relative to the elapsed time at the adaptive filter of the first embodiment;

FIG. 9 is a diagram illustrating an exemplary difference of a sensitivity function between a case of having the adaptive filter of the first present embodiment and a case of not having the adaptive filter;

FIG. 10 is a diagram illustrating transition of the adaptation coefficient of the adaptive filter of the first embodiment and transition of an adaptation coefficient of an adaptive filter in the related art;

FIG. 11 is a diagram illustrating an exemplary difference of a sensitivity function between the adaptive filter of the first embodiment and the adaptive filter in the related art;

FIG. 12 is a block diagram illustrating exemplary configurations of a first adaptive filter and a second adaptive filter according to a second embodiment;

FIG. 13 is a diagram illustrating an exemplary table of fixed coefficients in order to read coefficients to be set at computing units by a CPU of a third embodiment;

FIG. 14 is a diagram illustrating exemplary sensitivity characteristics of an adaptive filter using a coefficient set in the case where an estimation value of an external vibration frequency is lower than 1500 Hz; and

FIG. 15 is a diagram illustrating an exemplary sensitivity characteristic of the adaptive filter using a coefficient set in the case where the estimation value of the external vibration frequency is 1500 Hz or higher.

### DETAILED DESCRIPTION

In general, according to the present embodiment, a magnetic disk device includes a head and a controller. The head reads servo information on a disk. The controller performs position control for the head by using a high-order adaptive digital filter including a first variable coefficient and a second variable coefficient each based on positional error information generated from the servo information read by the head. The first variable coefficient is generated by adding the positional error information, a second value obtained by multiplying a first value obtained from primary delay of the first variable coefficient by an adaptation coefficient, and a fourth value obtained by multiplying a third value obtained from secondary delay of the first variable coefficient by a first coefficient. The second variable coefficient is generated by adding a fifth value obtained by multiplying the first variable coefficient by a second coefficient, a seventh value obtained by multiplying the first value by a sixth value that is obtained by inverting the adaptation coefficient to negative, and an eighth value obtained by multiplying a third coefficient by the third value. The adaptation coefficient is generated based on the positional error information and the first variable coefficient transitioning with an elapsed time.

A magnetic disk device, and a position control method according to embodiments will be described below in detail with reference to the accompanying drawings. Note that the present invention is not limited to these embodiments.

### First Embodiment

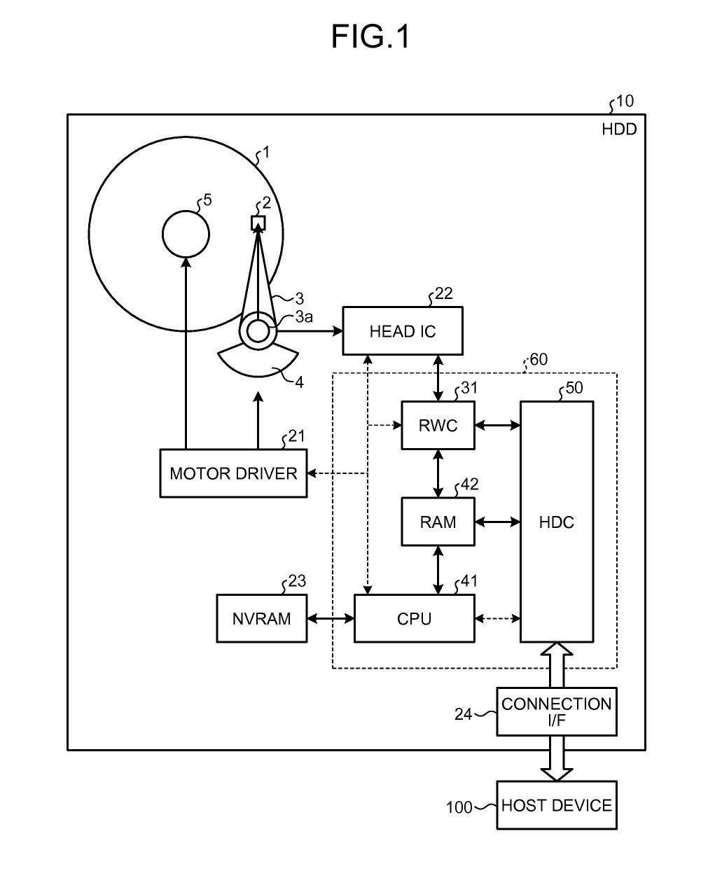

FIG. 1 is a block diagram illustrating a configuration of a hard disk drive (HDD) 10 according to a first embodiment. As illustrated in FIG. 1, the HDD 10 has a mechanical section including a magnetic disk 1, a head 2, an arm 3, a voice coil motor (VCM) 4, and a spindle motor (SPM) 5.

According to the present embodiment, a description will be given in the case of using the HDD 10 as an example of the magnetic disk device, but the magnetic disk device may be an optical disk drive, an MO drive, or the like.

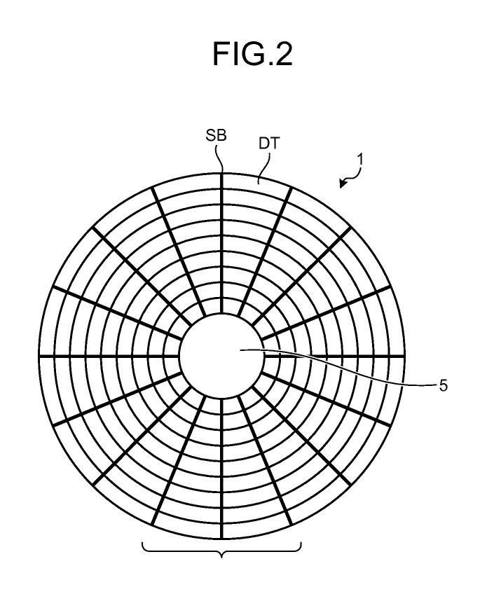

The magnetic disk 1 is fixed at the SPM 5 and rotated by rotatively driving the SPM 5. FIG. 2 is a diagram illustrating an exemplary configuration of a sector of the magnetic disk 1 in FIG. 1. As illustrated in FIG. 2, at least one surface of the magnetic disk 1 is provided as a recording surface on which information is magnetically recorded.

As illustrated in FIG. 2, for example, a plurality of concentric-circular tracks is defined on the recording surface, and each of the tracks includes a servo area SB and a data area DT. In the servo area SB, physical address information and servo information on the recording surface of the magnetic disk 1 are recorded. The servo information includes positional information to calculate deviation in a radial direction relative to the track. Further, in the data area DT, information to be recorded in the HDD 10 is recorded.

Referring back to FIG. 1, respective configurations of the HDD 10 will be described. The arm 3 includes the head 2 on one end portion, and a bearing 3a on the other end portion. The arm 3 is rotated around the bearing 3a in accordance with supply of drive current (or drive voltage) to the VCM 4, and moves the head 2 in the radial direction on the recording surface of the magnetic disk 1.

The head 2 includes a read head and a write head (both not illustrated). The read head reads information magnetically recorded on the recording surface of the magnetic disk 1. A signal read out is output to a head IC 22. The write head magnetically records information on the recording surface of the magnetic disk 1 in accordance with a write signal (write current) received via the head IC 22.

The VCM 4 is driven in accordance with a drive signal (current or voltage) supplied from a motor driver 21 described later, and rotates the arm 3.

The SPM 5 is driven in accordance with the drive signal (current or voltage) supplied from the motor driver 21, and rotates the magnetic disk 1.

Further, the HDD 10 includes the motor driver 21, the head IC 22, an NVRAM 23, a connection I/F 24, and a controller 60.

The motor driver 21 supplies the VCM 4 with the drive signal to drive the VCM 4 based on a control signal from the controller 60. Further, the motor driver 21 supplies the SPM 5 with the drive signal (current) to drive the SPM 5 based on the control signal from the controller 60.

The head IC 22 amplifies a signal received from the read head provided at the head 2 via a conductor pattern on the arm 3, and outputs the amplified signal to the controller 60 as read information. Further, the head IC 22 outputs a write signal in accordance with recording information received from the controller 60 to the write head provided at the head 2 via the conductor pattern on the arm 3.

The NVRAM 23 is a non-volatile semiconductor memory. The NVRAM 23 stores a program to be executed by a CPU 41 and various kinds of parameters utilized in processing executed in the CPU 41.

The connection I/F 24 connects a host device 100 and the HDD 10, and is utilized for communication related to exchange of data and commands between the host device 100 and the HDD 10. The HDD 10 is connected to the host device 100 via the connection I/F 24. This makes the HDD 10 function as a storage module of the host device 100.

The controller 60 is formed as a system on chip (SOC) which includes at least a read write channel (RWC) 31, the CPU 41, a RAM 42, and a hard disc controller (HDC) 50. Note that the controller 60 may have a configuration in which the RAM 42 is not included therein but the RAM 42 is connected to the outside of the controller 60.

The RAM 42 is a work memory (work area) for the RWC 31, CPU 41, and HDC 50. As the RAM 42, a DRAM which is a volatile memory is applied, for example.

In the case where the connection I/F 24 is the interface conforming to the standard of Serial Advanced Technology Attachment (SATA), the HDC 50 performs communication control with the host device 100, conforming to the SATA standard. According to the present embodiment, a description will be given for the case of using the SATA standard as the standard for the connection I/F, but other standards such as SAS and PCIe may be used, too.

The HDC 50 controls information exchange with the host device 100. The HDC 50 applies predetermined processing to and encodes decoded information from the RWC 31, and transmits the encoded information to the host device 100. Further, the HDC 50 applies predetermined processing to and decodes received information received from the host device 100, and outputs the decoded information to the RWC 31 as information to be recorded.

Further, in the case of receiving, from the host device 100, a write command including information of a logical address and a recording data length to start data recording, the HDC 50 extracts information of the logical address and the recording data length from the received write command. The extracted information of the logical address and the recording data length is output to the CPU 41.

The RWC 31 detects the servo information corresponding to the servo area SB from the read information received from the head IC 22, and extracts the address information and the positional information from the detected servo information. The extracted address information and positional information are output to the CPU 41.

Further, the RWC 31 detects information corresponding to the data area DT from the read information, and applies predetermined processing to and decodes the detected information. The decoded information is output to the HDC 50.

Further, the RWC 31 applies predetermined processing to and encodes the information to be recorded received from the HDC 50, and outputs the encoded information to the head IC 22 as the recording information. The RWC 31 utilizes the RAM 42 as a work memory in order to perform these plural processing.

The CPU 41 is a processor to control an entire HDD 10. For example, the CPU 41 executes a program stored in the NVRAM 23, and implements various kinds of control by using the RAM 42 as the work area.

For example, the CPU 41 performs rotation control of the VCM 4 and SPM 5, and reproduction processing control for the information from the magnetic disk 1.

For another example, the CPU 41 performs position control for the head 2 relative to the radial direction of the recording surface of the magnetic disk 1 based on the address information and positional information extracted from the servo information recorded in the magnetic disk 1. Feedback control is used for position control for the head 2 of the present embodiment.

In the feedback control, the CPU 41 calculates positional error information from an actual position based on the servo information read by the head 2 from the magnetic disk 1, and a target position by the feedback control. Further, the CPU 41 applies filtering to the calculated positional error information by using an adaptive filter.

In other words, the adaptive filter applies filtering processing to the positional error information. The adaptive filter of the present embodiment adaptively estimates unspecified frequency components of disturbance relative to the positional error information without using an FFT. According to the present embodiment, an infinite impulse response (IIR) adaptive filter is used as the adaptive filter to control positioning for the head 2 of the HDD 10.

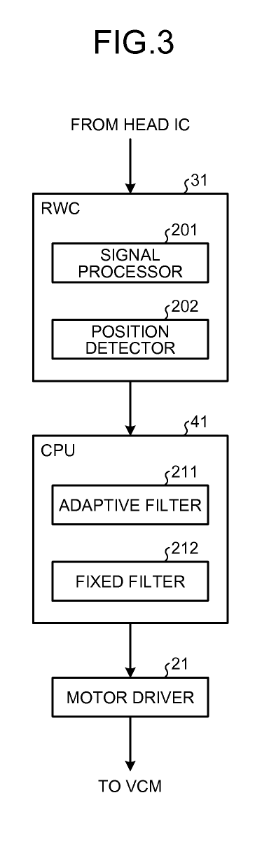

Next, a configuration to perform position control for the head 2 according to the present embodiment will be described. FIG. 3 is a diagram illustrating an exemplary configuration to perform position control for the head 2 of the present embodiment.

As illustrated in FIG. 3, the RWC 31 includes a signal processor 201 and a position detector 202. Further, the CPU 41 executes the program stored in the NVRAM 23, and implements an adaptive filter 211 and a fixed filter 212. Further, according to the present embodiment, position control for the head 2 is performed by the signal processor 201, position detector 202, adaptive filter 211, fixed filter 212, and motor driver 21.

The signal processor 201 of the RWC 31 receives and processes the read information from the head IC 22. The signal processor 201 applies processing such as demodulation and error correction to the received read information. The signal processor 201 outputs the processed read information to the position detector 202.

The position detector 202 detects the servo information from the read information received from the signal processor 201. The position detector 202 extracts the address information and positional information from the detected servo information. The position detector 202 outputs the extracted address information and positional information to the CPU 41.

The CPU 41 receives the address information and positional information from the position detector 202 of the RWC 31. Further, the CPU 41 calculates, from the address information and positional information, the positional error information indicating a difference between the target position and the actual position of the head 2.

The adaptive filter 211 of the CPU 41 receives the calculated positional error information. The adaptive filter 211 adaptively estimates, from the received positional error information, the unspecified frequency components of disturbance relative to the position control for the head 2, and applies the filtering processing (filtering) to the estimated frequency components with a distinctive characteristic. The adaptive filter 211 outputs the filtered information to the fixed filter 212.

The fixed filter 212 applies phase compensation and gain compensation in order to stabilize the feedback control in position control for the head 2. At the fixed filter 212, a filter coefficient is preliminarily set in order to implement a predetermined transfer function. Further, the fixed filter 212 outputs the filtered information to the motor driver 21.

The motor driver 21 drives the VCM 4 based on the information filtered at the adaptive filter 211 and the fixed filter 212, and moves the head 2 on the magnetic disk 1. The signal read by the read head provided at the head 2 from the recording surface of the magnetic disk 1 becomes the read information via the head IC 22, and is used for the feedback control in the position control for the head 2.

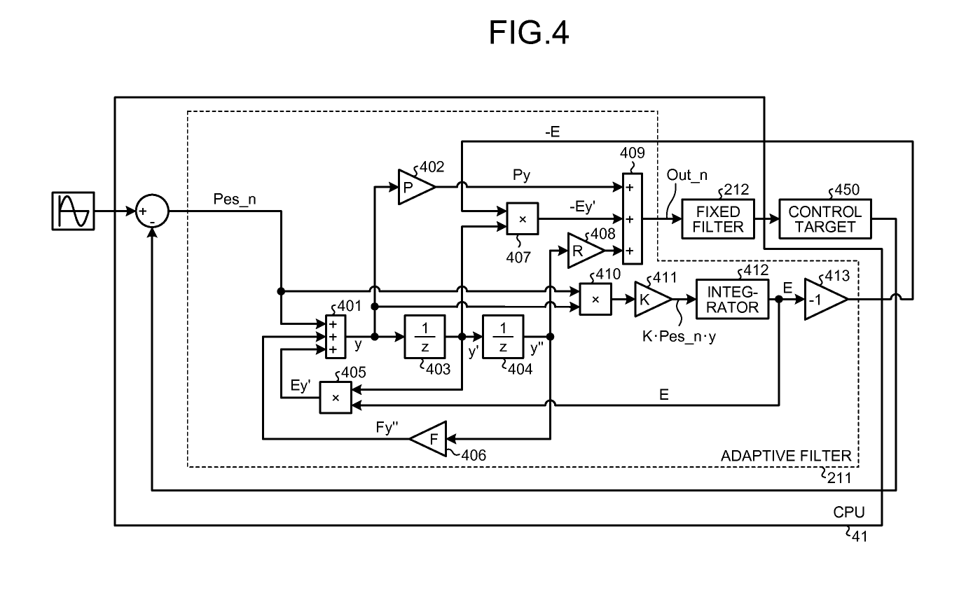

Next, a configuration of the adaptive filter 211 according to the present embodiment will be described. FIG. 4 is a block diagram illustrating an exemplary configuration of the adaptive filter 211 according to the present embodiment.

As illustrated in FIG. 4, a feedback control system is implemented in head position control at the CPU 41. The CPU 41 includes the adaptive filter 211 and the fixed filter 212 connected in series, and functions as a position control module.

The fixed filter 212 is disposed in a subsequent stage of the adaptive filter 211. Further, a control target 450 is disposed in a subsequent stage of the fixed filter 212. The fixed filter 212 may be disposed in a foregoing stage of the adaptive filter 211.

The control target 450 is a block including a range from the motor driver 21 to the head IC 22. Further, the read information output from the control target 450 is received in the CPU 41. Then, the positional error information, which is a computing result based on the servo information included in the read information inside the CPU 41, is received in the adaptive filter 211.

As illustrated in FIG. 4, the adaptive filter 211 includes a first adder 401, a first computing unit 402, a first delay device 403, second delay device 404, a first multiplier 405, a second computing unit 406, a second multiplier 407, a third computing unit 408, a second adder 409, a third multiplier 410, a fourth computing unit 411, an integrator 412, and a fifth computing unit 413.

The adaptive filter 211 of the present embodiment is a high-order adaptive digital filter having a denominator coefficient and a numerator coefficient each based on the positional error information generated from the servo information read by the head 2 at the time of performing position control for the head 2.

In the present embodiment, a description will be given for an example of using a secondary IIR adaptive filter as the adaptive filter 211, but the adaptive filter is not limited to the secondary one as long as being a high-order adaptive filter.

The adaptive filter 211 of the present embodiment makes a transfer function G(z) self-adapted in accordance with an optimization algorithm. The transfer function G(z) is represented by the following formula (1). Note that the adaptation coefficient is defined as E.

G(z)=(Pz²−E·z+R)/(z²−E·z−F) (1)

Coefficients P, R, and F are the coefficients set based on a center frequency to be attenuated by the adaptive filter 211, a notch depth, and a notch width, and also are the coefficients preliminarily set before shipment of the magnetic disk 1.

In other words, the present embodiment is an example in which the adaptive filter 211 is used as an adaptive notch filter. For example, there is a case of using the HDD 10 in an environment having vibration of a particular frequency (e.g., 1000 Hz). However, an external vibration frequency caused by vibration of the HDD 10 is varied by time and place. Therefore, in the case of removing vibration components caused by the external vibration, a frequency range may be enlarged. Therefore, according to the present embodiment, a narrow frequency range including the vibration components added to the HDD 10 can be attenuated by using the adaptive filter 211 as the adaptive notch filter. This can reduce a position error of the head 2.

The first adder 401 of the present embodiment outputs a denominator coefficient y derived from the transfer function G(z).

More specifically, the first adder 401 generates the denominator coefficient y by adding positional error information Pes_n, a value E·y′ obtained by multiplying a primary delay value y′ obtained from primary delay of the denominator coefficient y by the adaptation coefficient E and a value F·y″ obtained by multiplying a secondary delay value y″ obtained from secondary delay of the denominator coefficient y by the coefficient F.

More specifically, the first delay device 403 outputs the primary delay value y′ which is the primary delay of the denominator coefficient y. The second delay device 404 outputs the primary delay of the primary delay value y′, in other words, the secondary delay value y″ which is the secondary delay of the denominator coefficient y. The first multiplier 405 multiplies the primary delay value y′ by the adaptation coefficient E output from the integrator 412, and outputs the multiplied value to the first adder 401. The second computing unit 406 multiplies the secondary delay value y″ by a coefficient F, and outputs the multiplied value to the first adder 401.

Further, the second adder 409 of the present embodiment outputs a numerator coefficient Out_n derived from the transfer function G(z).

Specifically, the second adder 409 generates the numerator coefficient Out_n by adding a value P·y obtained by multiplying the denominator coefficient y by the coefficient P, a value −E·y′ obtained by multiplying the value y′ obtained from the primary delay of the numerator coefficient y by a value −E obtained by inverting the adaptation coefficient E to negative, and a value R·y″ obtained by multiplying the value y″ obtained from the secondary delay of the denominator coefficient y by the coefficient R.

More specifically, the first computing unit 402 multiplies the denominator coefficient y by the coefficient P, and outputs the multiplied value to the second adder 409. The second multiplier 407 multiplies the primary delay value y′ by the adaptation coefficient −E inverted to negative by the fifth computing unit 413, and outputs the multiplied value to the second adder 409. The third computing unit 408 multiplies the secondary delay value y″ by the coefficient R, and outputs the multiplied value to the second adder 409.

Further, the integrator 412 of the present embodiment outputs the adaptation coefficient E. The adaptation coefficient E is generated by the positional error information Pes_n and the denominator coefficient y each transitioning with elapsed time.

The integrator 412 of the present embodiment generates the adaptation coefficient E by integrating values obtained by multiplying the coefficient K by the values generated by multiplying the denominator coefficient y by the positional error information Pes_n. In other words, the integrator 412 determines, as the adaptation coefficient E, the value generated by adding K·Pes_n·y to an adaptation coefficient E′ in a previous sample.

More specifically, the third multiplier 410 multiplies the positional error information Pes_n by the denominator coefficient y. Further, the fourth computing unit 411 multiplies the value generated by multiplication at the third multiplier 410 by the coefficient K, and generates an integration value K·Pes_n·y to be integrated with the adaptation coefficient E′ in the previous sample. Note that a different value is set for the coefficient K in accordance with an embodiment.

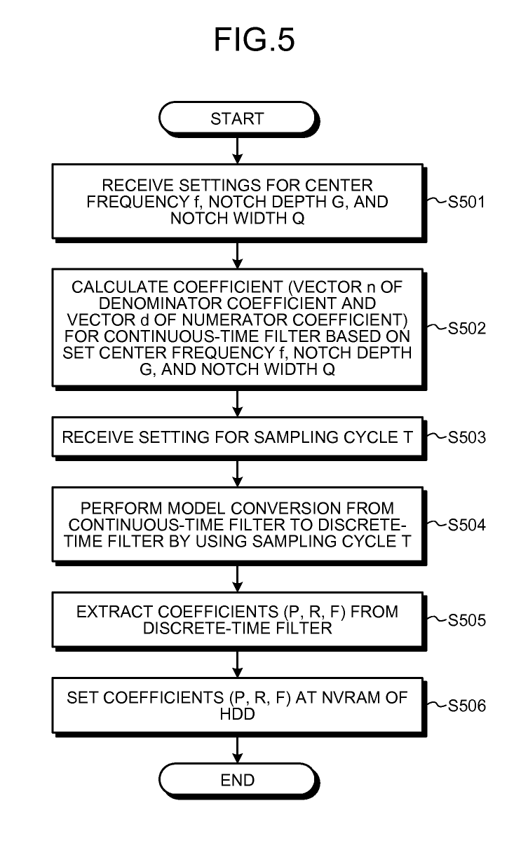

Next, calculation processing for a coefficient to be set at the HDD 10 of the present embodiment will be described. FIG. 5 is a flowchart illustrating a procedure of the above-described processing executed by the information processor according to the present embodiment. Note that the information processor is needed to be at least a device capable of executing the processing illustrated in FIG. 5, and may be a host device 100, for example. Further, any program may be used as a program for the information processor to execute the following processing, and for example, a MATLAB (registered trademark) may be possibly used.

First, the information processor receives settings for a center frequency f, a notch depth G, and a notch width Q (S501). To receive these settings, statements shown in (1) to (3) may be used.
(1) f=input (‘center frequency [Hz]:’)
(2) G=input (‘depth [Hz]:’)
(3) Q=input (‘width:’)

Next, the information processor calculates a coefficient (including a vector n of the denominator coefficient, and a vector d of the numerator coefficient) for a continuous-time filter based on the set center frequency f, notch depth G, and notch width Q (S502). To generate the continuous-time filter, statements shown in (4) to (7) may be used.
(4) k1=Q
(5) k2=k1*10̂(G/20)
(6) n=[1, 2*k1*2*pi*, (2*pi*f)̂2]
(7) d=[1, 2*k2*2*pi*f, (2*pi*f)̂2]

Next, the information processor receives setting for a sampling cycle T (S503). To receive the setting, a statement shown in (8) may be used.
(8) T=input (′sampling cycle [sec]:′)

Further, the information processor performs model conversion from the continuous-time filter including vector n of denominator coefficient, and vector d of numerator coefficient) to a discrete-time filter by using the sampling cycle T (S504). For this model conversion, a statement shown in (9) may be used. The statement shown in (9) is an example in which a statement “c2dm” is used for model conversion and also a prewarp method is used. Note that a vector of the denominator coefficient is defined as nd and a vector of the numerator coefficient is defined as dd in a discrete model.
(9) [nd, dd]=c2dm(n, d, T, ‘prewarp’, 2*pi*f)

Further, the information processor extracts the coefficients (P, R, F) from the discrete-time filter (S505). To extract the coefficients (P, R, F), statements shown in (10) to (12) may be used. Note that the vector nd (number k) indicates a k^{th} element of the vector nd.
(10) P=nd(1)
(11) R=nd(2)
(12) F=−dd(3)

Next, the information processor sets the extracted coefficients (P, R, F) at the NVRAM 23 of the HDD 10 (S506).

This enables the adaptive filter 211 of the HDD 10 to utilize the coefficients P, R, F. The HDD 10 of the present embodiment can adjust a peak and a width of gain of the adaptive filter 211 with the coefficients P, R, F set at the adaptive filter 211. This can improve accuracy of the adaptive filter in accordance with the embodiment by adjusting the coefficients P, R, F.

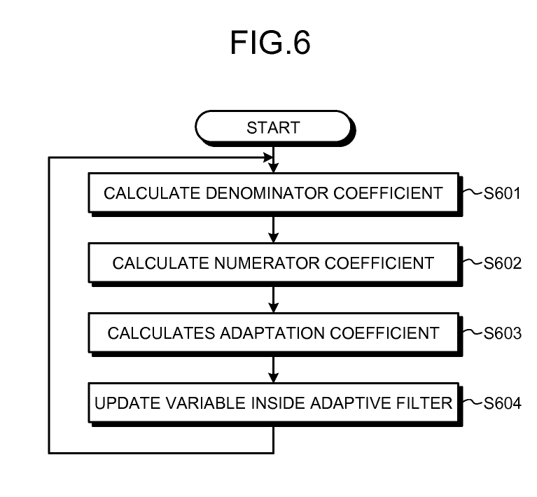

Next, the processing performed by the adaptive filter 211 of the HDD 10 of the present embodiment will be described. FIG. 6 is a flowchart illustrating a procedure of the above-described processing performed by the adaptive filter 211 of the present embodiment.

First, the first adder 401 or the like of the adaptive filter 211 calculates the denominator coefficient y (S601). A formula to calculate the denominator coefficient y is shown in (2) below. Here, a value calculated in latest S603 is used as the adaptation coefficient E. Note that in the case of first S601, an initial value is set for the adaptation coefficient E. The initial value of the adaptation coefficient E is a value set in accordance with an embodiment. Further, y′ is a latest value of the denominator coefficient, and y″ is a value of the denominator coefficient before the latest value. Note that in the case of first S601, initial values are set for y′ and y″.

y=Pes_n+E·y′+F·y″ (2)

The second adder 409 or the like of the adaptive filter 211 calculates the numerator coefficient Out_n (S602). A formula to calculate the numerator coefficient Out_n is shown in (3) below.

Out_n=P·y−E·y′+R·y″ (3)

The integrator 412 or the like of the adaptive filter 211 calculates the adaptation coefficient E (S603). A formula to calculates the adaptation coefficient E is shown in (4) below. Note that E′ is a latest value of the adaptation coefficient.

E=E′+K*Pes_n*y′ (4)

Further, the first delay device 403 and the second delay device 404 update the coefficient inside the adaptive filter 211 based on the denominator coefficient y output from the first adder 401 (S604). For updating, formulas (5) and (6) are used.

y″=y′ (5)

y′=y (6)

After that, the CPU 41 again calculates the positional error information based on the address information and the positional information newly received from the RWC 31. The processing from S601 is repeated again by the positional error information being received as a new sample value. The positional error can be corrected by repeating the above processing.

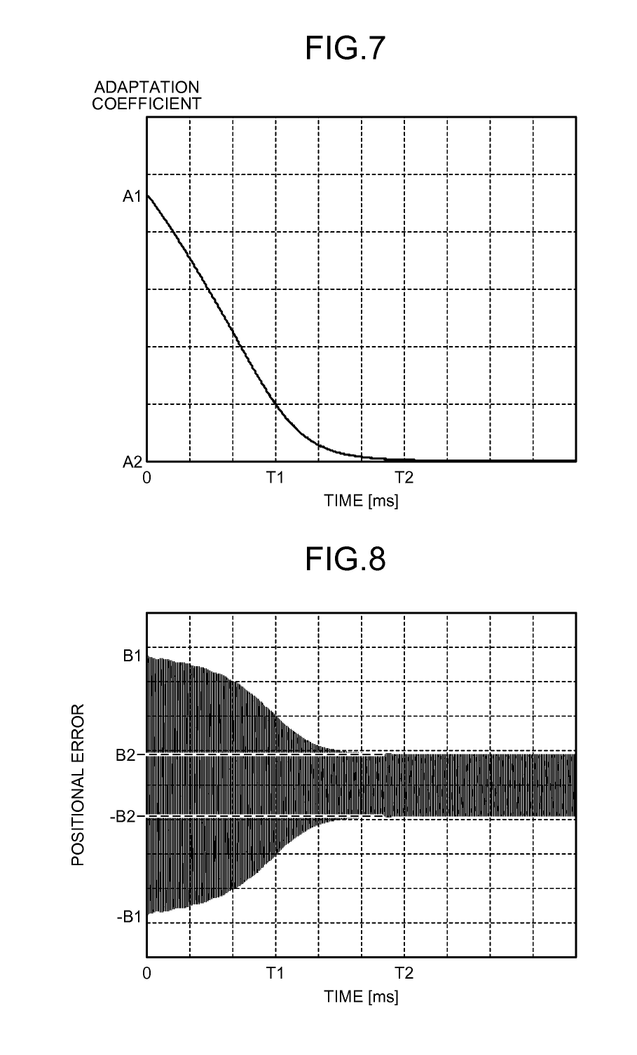

FIG. 7 is a diagram illustrating transition of the adaptation coefficient E relative to an elapsed time at the adaptive filter 211 of the present embodiment. As illustrated in FIG. 7, an initial value A1 is set for the adaptation coefficient E at time 0 [ms]. Then, the adaptation coefficient E gradually changes from the initial value A1 to a value A2 by the above-described adaptive filter 211 repeating the processing. After that, the adaptation coefficient E moderately changes from approximately time T1, and the adaptation coefficient E converges to the value A2 at approximately time T2.

The positional error also converges along with convergence of the adaptation coefficient E. FIG. 8 is a diagram illustrating transition of the positional error relative to the elapsed time at the adaptive filter 211 of the present embodiment. As illustrated in FIG. 8, disturbance having a particular frequency is applied to the feedback control system at time 0 [ms], and an amplitude value of the positional error information becomes ±B1. Then, the positional error is getting smaller and smaller with the elapsed time. Around time T1 at which the adaptation coefficient E changes moderately, the positional error changes moderately, too. Further, the positional error also comes to converge to an amplitude value ±B2 (B2<B1) at approximately time T2 at which the adaptation coefficient E converges to the value A2. In other words, the coefficient of the adaptive filter 211 is optimized at approximately time T2.

Thus, since the external vibration frequency is unknown, the positional error of the head 2 can be improved even in the case where the adaptation coefficient E is deviated from an optimal value at the beginning of control because the adaptation coefficient E converges to the optimal value in a certain elapsed time.

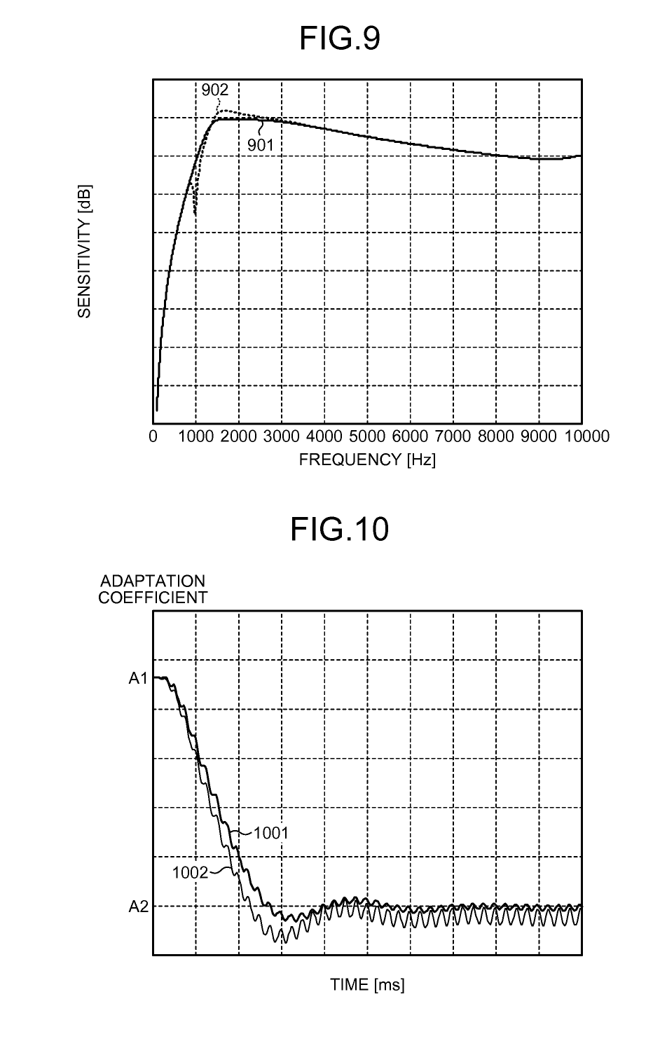

FIG. 9 is a diagram illustrating a difference of a sensitivity function between a case of having the adaptive filter 211 of the present embodiment and a case of not having the adaptive filter. As illustrated in FIG. 9, compared to a characteristic 901 in the case of not having the adaptive filter 211, a characteristic 902 in the case of having the adaptive filter 211 can reduce the gain (sensitivity) of the sensitivity function at around 1000 Hz set as the center frequency. This can reduce the positional error by using the adaptive filter 211 in the case where the HDD 10 vibrates at the frequency around 1000 Hz.

By the way, the HDD provided with the IIR adaptive filter is proposed in the related art. The IIR adaptive filter provided to the HDD in the related art includes output of the adaptive filter as an adaptation law. In contrast, the adaptive filter of the present embodiment has a configuration not including output of the adaptive filter as the adaptation law. A difference of an effect between the adaptive filter in the related art and the adaptive filter of the present embodiment will be described.

FIG. 10 is a diagram illustrating transition of the adaptation coefficient E of the adaptive filter 211 of the present embodiment and transition of the adaptive filter in the related art. In the example illustrated in FIG. 10, transition of the adaptation coefficient E of the adaptive filter 211 of the present embodiment is defined as transition 1001, and the transition of the adaptive filter in the related art is defined as transition 1002. Note that the initial value A1 is set at both adaptive filters as the adaptation coefficient.

As illustrated in FIG. 10, the adaptation coefficient E of the adaptive filter 211 of the present embodiment converges earlier compared to the adaptation coefficient of the adaptive filter in the related art. Further, the adaptation coefficient E of the adaptive filter 211 of the present embodiment has a smaller change width of the adaptation coefficient after convergence, compared to the adaptation coefficient of the adaptive filter in the related art.

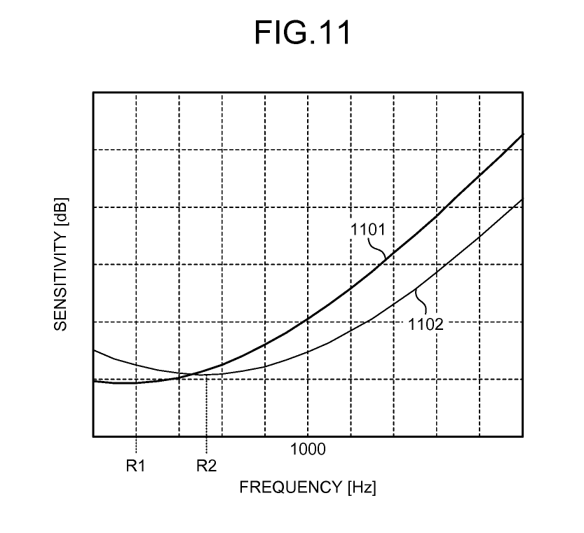

FIG. 11 is a diagram illustrating an exemplary difference of the sensitivity function between the adaptive filter 211 of the present embodiment and the adaptive filter in the related art. In the example illustrated in FIG. 11, the frequency around 1000 Hz at which the HDD 10 vibrates is illustrated. In the example illustrated in FIG. 11, a sensitivity function 1101 of the adaptive filter in the related art and a sensitivity function 1102 of the adaptive filter 211 of the present embodiment are illustrated.

A frequency R2 where gain of the sensitivity function 1102 in the adaptive filter 211 of the present embodiment is lowest within a range illustrated in FIG. 11 is closer to frequency 1000 Hz, compared to a frequency R1 where gain of the sensitivity function 1101 in the adaptive filter in the related art is lowest within the range illustrated in FIG. 11. Thus, it can be confirmed that accuracy of the adaptive filter 211 of the present embodiment is more improved, compared to the adaptive filter in the related art.

### Second Embodiment

In the first embodiment, an example of providing one adaptive filter has been described. However, providing a plurality of adaptive filters is not limited in the first embodiment. Now, in a second embodiment, a case of providing a plurality of adaptive filters will be described.

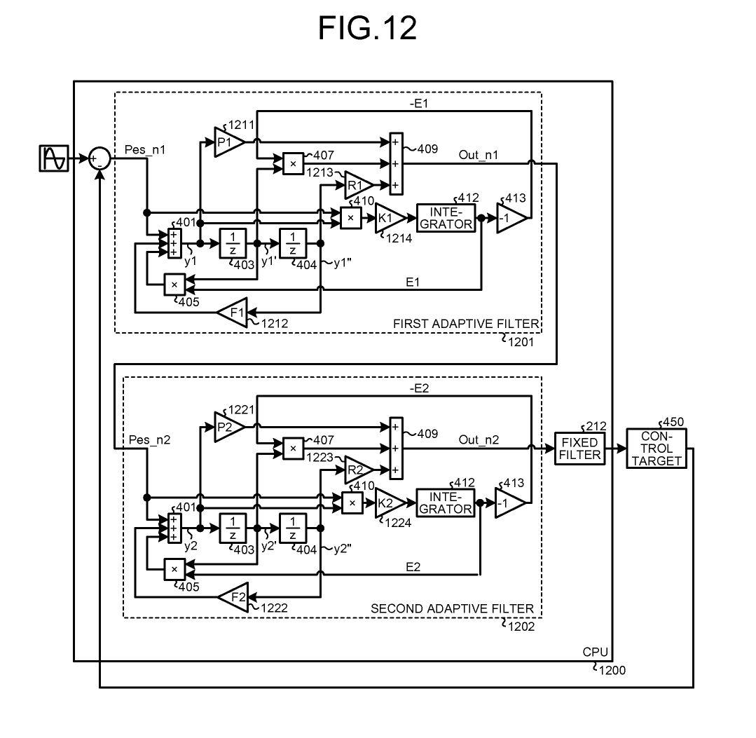

Subsequently, configurations of the plurality of adaptive filters according to the present embodiment will be described. FIG. 12 is a block diagram illustrating exemplary configurations of a first adaptive filter 1201 and a second adaptive filter 1202 in a CPU 1200 according to the present embodiment. Note that same configurations as the first embodiment will be denoted by the same reference signs and a description therefor will be omitted.

The first adaptive filter 1201 have different values set at a first computing unit 1211, a second computing unit 1212, a third computing unit 1213, and a fourth computing unit 1214, compared to the adaptive filter 211 of the first embodiment.

For instance, a coefficient P1 set at the first computing unit 1211, a coefficient F1 set at the second computing unit 1212, a coefficient R1 set at the third computing unit 1213, and a coefficient K1 set at the fourth computing unit 1214 in the first adaptive filter 1201 are the coefficients determined based on a first center frequency to be attenuated at the first adaptive filter 1201. Note that a calculation method for the coefficients is same as the first embodiment.

In FIG. 12, positional error information received in the first adaptive filter 1201 is defined as Pes_n1. Further, a first adder 401 of the first adaptive filter 1201 outputs a denominator coefficient y1. By this, a first delay device 403 of the first adaptive filter 1201 outputs a primary delay value y1′. A second delay device 404 of the first adaptive filter 1201 outputs a secondary delay value y1″. Then, a second adder 409 of the first adaptive filter 1201 generates a numerator coefficient Out_n1, and outputs the numerator coefficient to the second adaptive filter 1202.

The second adaptive filter 1202 has different values set at a first computing unit 1221, a second computing unit 1222, a third computing unit 1223, and a fourth computing unit 1224, compared to the adaptive filter 211 of the first embodiment.

For instance, a coefficient P2 set at the first computing unit 1221, a coefficient F2 set at the second computing unit 1222, a coefficient R2 set at the third computing unit 1223, and a coefficient K2 set at the fourth computing unit 1224 in the second adaptive filter 1202 are the coefficients determined based on a second center frequency to be attenuated at the second adaptive filter 1202. Note that a calculation method for the coefficients is same as the first embodiment. Further, the second center frequency is a frequency different from the first center frequency.

The second adaptive filter 1202 receives a numerator coefficient Out_n1 output from the first adaptive filter 1201 as positional error information Pes_n2.

Further, a first adder 401 of the second adaptive filter 1202 outputs a denominator coefficient y2. By this, a first delay device 403 of the second adaptive filter 1202 outputs a primary delay value y2′. A second delay device 404 of the second adaptive filter 1202 outputs a secondary delay value y2″. Further, a second adder 409 of the second adaptive filter 1201 generates a numerator coefficient Out_n2, and outputs the numerator coefficient to a fixed filter 212.

The coefficient P1, coefficient F1, coefficient R1, and coefficient K1 set at the respective computing units 1211 to 1214 of the first adaptive filter 1201 are different from the coefficient P2, coefficient F2, coefficient R2, and coefficient K2 set at the respective computing units 1221 to 1224 of the second adaptive filter 1202 in the present embodiment.

In other words, according to the present embodiment, after providing the first adaptive filter 1201 and the second adaptive filter 1202, the coefficients corresponding to the respective control targets are set, thereby achieving to handle a plurality of external vibration frequency components. In other words, in the case where external vibration is generated at the HDD 10 of the present embodiment, influence from the plurality of frequency components can be removed even in the case where the plurality of frequency components are contained in the external vibration. This reduces the influence from the external vibration, and can suppress a positional error.

Further, according to the present embodiment, the case where the two adaptive filters are connected in series has been described, but three or more adaptive filters may be connected in series as well. According to the present embodiment, adaptation to the plurality of frequency components is enabled by providing the plurality of adaptive filters.

### Third Embodiment

In above-described embodiments, a case where a coefficient value set at a computing unit is not changed has been described. In contrast, in a third embodiment, a description will be given for a case where a coefficient set at a computing unit is switched.

An adaptive filter of the third embodiment has a configuration same as an adaptive filter of the first embodiment, and the description therefor will be omitted.

Further, a CPU 41 of the present embodiment switches coefficients set at a first computing unit 402, a second computing unit 406, and a third computing unit 408 of an adaptive filter 211 illustrated in FIG. 4, as needed. In the present embodiment, two kinds of coefficients R, P, F are stored by defining 1500 Hz as a boundary of an estimation value of an external vibration frequency.

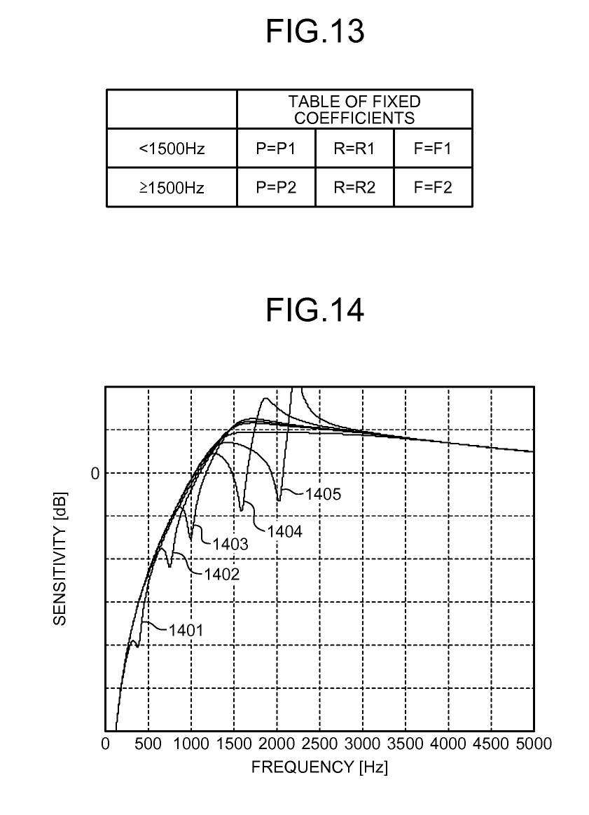

FIG. 13 is a diagram illustrating an exemplary table of fixed coefficients in order to read coefficients which the CPU 41 of the present embodiment sets at the computing units. The table of the fixed coefficients illustrated in FIG. 13 is stored in an NVRAM 23, for example.

Further, the CPU 41 switches the coefficients to be set at the first computing unit 402, second computing unit 406, and third computing unit 408 in accordance with the estimation value of the external vibration frequency of the HDD 10 estimated at the adaptive filter 211. For example, in the case where the estimation value of the external vibration frequency of the HDD 10 is lower than 1500 Hz, a value P1 is set for the coefficient P of the first computing unit 402, a value F1 is set for the coefficient F of the second computing unit 406, and a value R1 is set for the coefficient R of the third computing unit 408.

For example, in the case where the estimation value of the external vibration frequency of the HDD 10 is 1500 Hz or higher, a value P2 is set for the coefficient P of the first computing unit 402, a value F2 is set for the coefficient F of the second computing unit 406, and a value R2 is set for the coefficient R of the third computing unit 408.

FIG. 14 is a diagram illustrating exemplary sensitivity characteristics of an adaptive filter 211 using a group of the coefficients (P1, R1, F1) set in the case where the estimation value of external vibration frequency is lower than 1500 Hz. In the example illustrated in FIG. 14, a sensitivity characteristic 1401 indicates a case where the estimation value is around 400 Hz. A sensitivity characteristic 1402 indicates a case where the estimation value is around 800 Hz. A sensitivity characteristic 1403 indicates a case where the estimation value is around 1000 Hz. A sensitivity characteristic 1404 indicates a case where the estimation value is around 1600 Hz. A sensitivity characteristic 1405 indicates a case where the estimation value is around 2000 Hz. As illustrated in FIG. 14, in the adaptive filter 211 of the present embodiment, a peak of sensitivity function becomes high in the case of tracking a high frequency around 2000 Hz. Therefore, feedback control system becomes unstable. This deteriorates accuracy of the adaptive filter 211.

Therefore, according to the present embodiment, in the case where the estimation value of the external vibration frequency is at a reference frequency (1500 Hz in the present embodiment) or higher, the coefficients to be set at the computing units are switched.

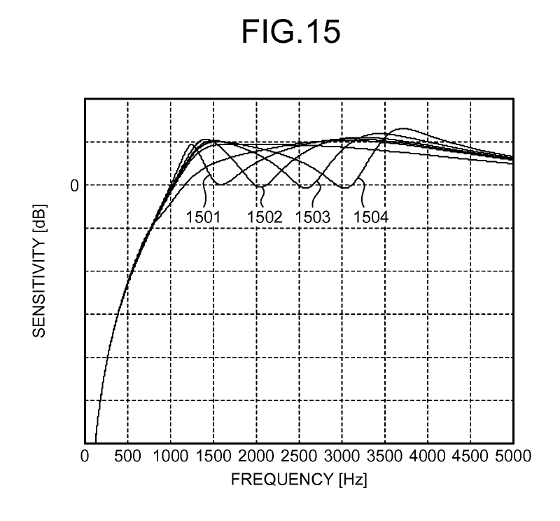

FIG. 15 is a diagram illustrating exemplary sensitivity characteristics of the adaptive filter 211 using a group of the coefficients (P2, R2, F2) set in the case where the estimation value of external vibration frequency is 1500 Hz or higher. In the example illustrated in FIG. 15, a sensitivity characteristic 1501 indicates a case where the estimation value is around 1500 Hz. A sensitivity characteristic 1502 indicates a case where the estimation value is around 2000 Hz. A sensitivity characteristics 1503 indicates a case where the estimation value is around 2500 Hz. A sensitivity characteristics 1504 indicates a case where the estimation value is around 3000 Hz. As illustrated in FIG. 15, in the case where the estimation value of the external vibration frequency becomes high, the peak of the sensitivity function can be more suppressed, compared to the case illustrated in FIG. 14. This can prevent deterioration of accuracy of the adaptive filter 211, and keep stability of a feedback control system. This improves a positional error of a head 2.

According to the present embodiment, the description has been given for the example in which the group of coefficients is switched between the case where the estimation value of the external vibration frequency is the reference frequency (1500 Hz in the present embodiment) or higher and the case where the estimation value is lower than the reference frequency (1500 Hz in the present embodiment). However, not limited to such switching, the group of coefficients may be switched between a case where the estimation value is higher than the reference frequency and a case where the estimation value is the reference frequency or lower. Further, the reference frequency is not limited to 1500 Hz, and may be other frequencies.

Note that the case where external vibration is caused by spot vibration has been described in the above-described embodiments, but positioning accuracy for the head 2 can be also improved in the same manner in the case where the external vibration is caused by sweep vibration.

According to the above-described embodiments, positioning accuracy for the head 2 can be improved by providing an IIR adaptive filter in a control system for positioning the head 2 of the HDD in the case where external vibration is caused by spot vibration or the like.

According to the above-described embodiments, it is possible to suppress fluctuation of a value after convergence of the adaptation coefficient and reduction of deviation, compared to the related art.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device, comprising:
a head that reads servo information on a disk; and
a controller that performs position control for the head by using a high-order adaptive digital filter, the high-order adaptive digital filter including a first variable coefficient and a second variable coefficient based on positional error information generated from the servo information read by the head,
the first variable coefficient being generated by adding the positional error information, a second value, and a fourth value, the second value being obtained by multiplying a first value by an adaptation coefficient, the first value being obtained from primary delay of the first variable coefficient, the fourth value being obtained by multiplying a third value by a first coefficient, the third value being obtained from secondary delay of the first variable coefficient,
the second variable coefficient being generated by adding a fifth value, a seventh value, and an eighth value, the fifth value being obtained by multiplying the first variable coefficient by a second coefficient, the seventh value being obtained by multiplying the first value by a sixth value that is obtained by inverting the adaptation coefficient to negative, the eighth value being obtained by multiplying the third value by a third coefficient,
the adaptation coefficient being generated based on the positional error information and the first variable coefficient transitioning with an elapsed time.

2. The magnetic disk device according to claim 1, wherein the adaptation coefficient is generated by adding a tenth value to an adaptation coefficient in a previous sample, the tenth value being generated by multiplying a fourth coefficient by a ninth value, the ninth value being obtained by multiplying the first variable coefficient by the positional error information.

3. The magnetic disk device according to claim 1, wherein the controller includes a plurality of adaptive digital filters connected in series, the plurality of adaptive digital filters being provided with the first coefficient, the second coefficient, and the third coefficient which are varied by the adaptive digital filters.

4. The magnetic disk device according to claim 3, wherein the controller further includes the plurality of adaptive digital filters connected in series, the plurality of adaptive digital filters being provided with the fourth coefficient varied by the adaptive digital filters.

5. The magnetic disk device according to claim 1, further comprising a storage unit that stores a plurality of the first coefficients, the second coefficients, and the third coefficients,
wherein the controller switches the first coefficient, the second coefficient, and the third coefficient to be used at the adaptive digital filter based on an estimation value of an external vibration frequency of the magnetic disk device.

6. The magnetic disk device according to claim 4, wherein
the storage unit stores a first coefficient, a second coefficient, and a third coefficient in the case where the estimation value is lower than a first frequency, and stores a first coefficient, a second coefficient, and a third coefficient in the case where the estimation value is higher than the first frequency, and
the controller switches the first coefficient, the second coefficient, and the third coefficient based on whether the estimation value is the first frequency or higher.

7. The magnetic disk device according to claim 1, wherein the high-order adaptive digital filter is a notch filter related to a particular frequency.

8. The magnetic disk device according to claim 7, wherein the first coefficient, the second coefficient, and the third coefficient are determined based on the particular frequency.

9. The magnetic disk device according to claim 8, wherein the first coefficient, the second coefficient, and the third coefficient are further extracted from coefficients of a discrete-time filter converted from a continuous-time filter that is set based on the particular frequency.

10. The magnetic disk device according to claim 1, wherein the adaptive digital filter is an infinite impulse response digital filter.

11. A position control method executed in a magnetic disk device including a head that reads servo information on a disk, comprising:
filtering positional error information by using a high-order adaptive digital filter, the high-order adaptive digital filter including a first variable coefficient and a second variable coefficient based on the positional error information generated from the servo information read by the head,
the first variable coefficient being generated by adding the positional error information, a second value, and a fourth value, the second value being obtained by multiplying a first value by an adaptation coefficient, the first value being obtained from primary delay of the first variable coefficient, the fourth value being obtained by multiplying a third value by a first coefficient, the third value being obtained from secondary delay of the first variable coefficient,
the second variable coefficient being generated by adding a fifth value, a seventh value, and an eighth value, the fifth value being obtained by multiplying the first variable coefficient by a second coefficient, the seventh value being obtained by multiplying the first value by a sixth value that is obtained by inverting the adaptation coefficient to negative, the eighth value being obtained by multiplying the third value by a third coefficient,
the adaptation coefficient being generated based on the positional error information and the first variable coefficient transitioning with an elapsed time.

12. The position control method according to claim 11, wherein the adaptation coefficient is generated by adding a tenth value to an adaptation coefficient in a previous sample the tenth value being generated by multiplying a fourth coefficient by a ninth value, the ninth value being obtained by multiplying the first variable coefficient by the positional error information.

13. The position control method according to claim 11, comprising filtering the positional error information by using a plurality of adaptive digital filters connected in series, the plurality of adaptive digital filters being provided with the first coefficient, the second coefficient, and the third coefficient which are varied by the adaptive digital filters.

14. The position control method according to claim 13, further comprising filtering the positional error information by using the plurality of adaptive digital filters, the plurality of adaptive digital filters having the fourth coefficient varied by the adaptive digital filters.

15. The position control method according to claim 11, wherein
the magnetic disk device includes a storage unit that stores a plurality of the first coefficients, the second coefficients, and the third coefficients, and
the first coefficient, the second coefficient, and the third coefficient to be used at the adaptive digital filter are switched based on an estimation value of an external vibration frequency of the magnetic disk device.

16. The position control method according to claim 14, wherein
the storage unit stores a first coefficient, a second coefficient, and a third coefficient in the case where the estimation value is lower than a first frequency, and a first coefficient, a second coefficient, and a third coefficient in the case where the estimation value is higher than the first frequency, and
the first coefficient, the second coefficient, and the third coefficient are switched based on whether the estimation value is the first frequency or higher.

17. The position control method according to claim 11, wherein the high-order adaptive digital filter is a notch filter related to a particular frequency.

18. The position control method according to claim 17, wherein the first coefficient, the second coefficient, and the third coefficient are determined based on the particular frequency.

19. The position control method according to claim 18, wherein the first coefficient, the second coefficient, and the third coefficient are further extracted from coefficients of a discrete-time filter converted from a continuous-time filter that is set based on the particular frequency.

20. The position control method according to claim 11, wherein the adaptive digital filter is an infinite impulse response digital filter.
